(19) United States
(12) Patent Application Publication
(10) Pub. No.: US 2008/0267553 A1
(43) Pub. Date: Oct. 30, 2008

(54) TAPER ROLLER BEARING

(75) Inventors: Brian Edward Earthrowl, Norfolk (GB); Martin Janek Caspall, Norfolk (GB)

Correspondence Address: STRATEGIC PATENT GROUP, P.C., P.O. BOX 1329, MOUNTAIN VIEW, CA, 94042, US

(73) Assignee: COOPER ROLLER BEARINGS COMPANY LIMITED, Norfolk (GB)

(21) Appl. No.: 12/108,355

(22) Filed: Apr. 23, 2008

(30) Foreign Application Priority Data
Apr. 25, 2007 (GB) 0707940.3

(51) Int. Cl. F16C 33/58

(52) U.S. Cl. 384/571

(57) ABSTRACT

A split taper roller bearing comprising an inner ring including an inner tapered race, an outer ring including an outer tapered race, a cage mounted between the inner and outer tapered races, said cage mounting tapered rollers which engage the inner and outer races, said inner ring and inner tapered race, outer ring and outer tapered race, and cage each comprising two generally semicircular parts, the relevant semicircular parts being mounted end-to-end to provide a circular component, whereby the two semicircular parts of the inner ring and inner tapered race, outer ring and outer tapered race, and cage, may be separated from one another to allow the taper roller bearing to be dismantled when worn without removal of the component supported by the bearing.

### CROSS-REFERENCE TO RELATED APPLICATIONS

This application claims benefit of foreign priority under 35 USC §119, to Great Britain Patent Application 0707940.3, filed on Apr. 25, 2007, which is incorporated herein by reference.

### FIELD OF THE INVENTION

The present invention relates to a taper roller bearing.

### BACKGROUND OF THE INVENTION

Cylindrical roller bearings generally comprise an inner ring which includes an outwardly facing raceway or bearing surface, an outer ring which includes an inner facing raceway, and mounted between them, a row of rollers which engage the two raceways, the rollers being mounted in a cage.

In a cylindrical roller bearing thrust loads are carried between the ends of the rollers and adjacent faces of roller guide lips. This is a sliding contact which is difficult to lubricate and thus the thrust load carrying capacity is relatively low compared to other bearing types, particularly at high shaft speeds.

One bearing type that is able to support high thrust loads is the taper roller bearing. In this arrangement, the raceways and rollers have conical surfaces. For a single raceway, the apices of the cones of the raceways and rollers are common and coincide with the bearing centre line.

Taper roller bearings are used extensively, particularly in gearboxes and axle boxes. However, one of the major disadvantages of taper roller bearings is that it is not easy to replace relevant parts of the bearing when worn. To do so, it is necessary to substantially dismantle the gear box or axle box because one part of the taper roller bearing, for example the inner ring is mounted to a shaft, and the outer ring to a housing. The taper roller bearing can only be removed from the shaft or the housing by axial movement so this usually means that the shaft has to be disconnected for the bearing to be disassembled.

In many situations, this is a complex and time consuming task, particularly where the components which are being mounted are large, for example a shaft in a marine environment.

It would be preferable to be able to dismantle and replace the worn bearing components without having to remove, for example, the shaft from the gear box or axle.

The present invention provides a taper roller bearing which obviates this difficulty.

### SUMMARY OF THE INVENTION

According to a first aspect, the present invention provides a taper roller bearing comprising an inner ring including an inner tapered race; an outer ring including an outer tapered race; and a cage mounted between the inner and outer tapered races, said cage mounting tapered rollers which engage the inner and outer races, said inner ring and inner tapered race, outer ring and outer tapered race, and cage each comprising two generally semicircular parts, the relevant semicircular parts being mounted end-to-end to provide a circular component.

In this way, the two semicircular parts of the inner ring and inner tapered race, outer ring and outer tapered race, and cage, may be separated from one another to allow the taper roller bearing to be dismantled when worn and the relevant components, for example the races and/or the rollers to be replaced, and reassembled.

In a preferred arrangement, said inner ring mounts a second inner tapered race, said outer ring mounts a second outer tapered race, a cage (which may be the same cage) mounted between the second inner and outer tapered races, said cage mounting a second set of tapered rollers which engage the second inner and outer races, said inner ring and inner tapered race, outer ring and outer tapered race, and cage each comprising two generally semicircular parts, the relevant semicircular parts being mounted end-to-end to provide a circular component, the taper of the second inner and outer races and the second set of rollers being oppositely disposed to the taper of the first inner and outer races and first set of rollers.

Thus the split taper bearing is preferably a double row bearing with the rows set in a back-to-back format (i.e. with inwardly convergent contact angles) to give a bi-directional thrust load carrying capability.

Preferably the inner and/or outer ring is split using an angled cut to provide the two semicircular portions. In this way, the passage of the rollers over the joint is smoothed as the joint is set at an angle to the axis of rotation of the rollers. The magnitude of this angle is a compromise between ease of assembly and smooth running. For smooth running the angle should be as large as possible, but because of the overhang from the diameter, this causes problems in fitting, particularly the inner race over the shaft. In the taper bearing, the joint angle has to be adjusted to allow for race surfaces are that are conical rather than cylindrical.

The range of angles of the split relative to the axis of the bearing is typically between 6 degrees and 20 degrees.

Where the inner ring is to mount a shaft, preferably the inner ring is clamped to the shaft by clamping rings.

### BRIEF DESCRIPTION OF THE DRAWINGS

We will now describe split taper roller bearings comprising preferred embodiments of the invention with reference to the accompanying drawings in which:—

FIG. 1 is an axial section through a split taper roller bearing in accordance with a first embodiment of the invention,

FIG. 2 is a perspective view of a cage for use in the bearing of FIG. 1,

FIG. 3 is a perspective view of part of a so-called cartridge which mounts the outer ring, and

FIG. 4 is an axial section through the cartridge of FIG. 3.

### DESCRIPTION OF THE INVENTION

The present invention relates to a taper roller bearing. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

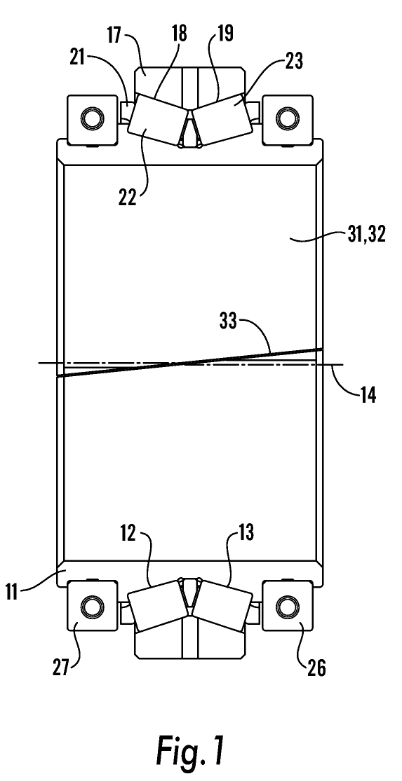

Referring to FIG. 1, there is shown a taper roller bearing in accordance with the invention. An inner ring 11 includes two raceways 12, 13 which each include bearing surfaces. The two raceways 12, 13, are set in a back-to-back format, that is they are set at opposite angles to the axis 14 of the bearing i.e. they have opposite tapers.

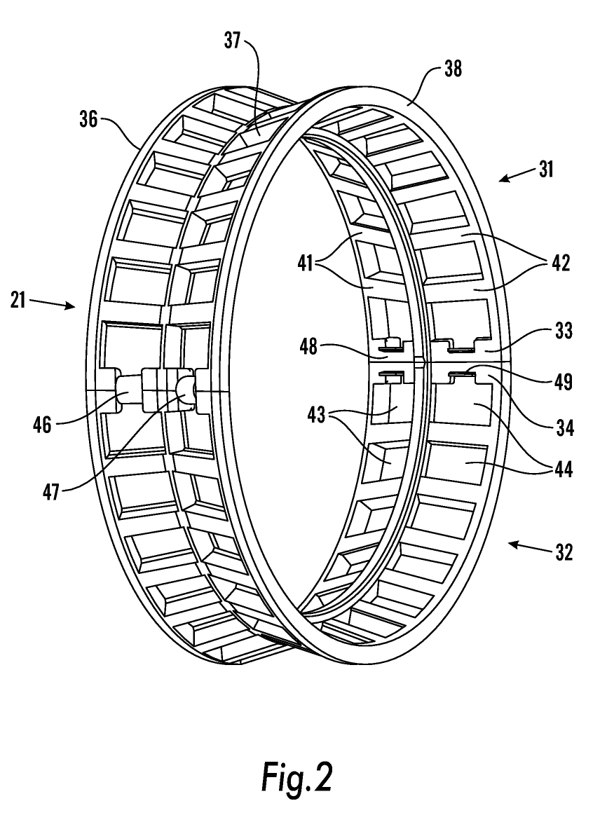

There is furthermore provided an outer ring 17 with two raceways 18, 19 at similar (but not identical as will be clear later) opposite angles to the axis 14 to the raceways 12, 13. Mounted between the inner 11 and outer 17 rings is a circular cage 21 (illustrated in more detail in FIG. 2), the cage mounting two side by side rows of rollers 22, 23, rollers 22 being mounted between raceways 12 and 18, and rollers 23 being mounted between raceways 13 and 19. The rollers are slightly conical. The apices of the cones of the raceways 12 and 18 and rollers 23 are common and lie on the bearing centre line, and the apices of the cones of the raceways 12 and 18 and rollers 23 are common and lie on the bearing centre line, the two apices lying on the axis on opposite sides of the bearing.

The inner ring 11 mounts two clamping rings 26, 27 which retain the cage 21 axially.

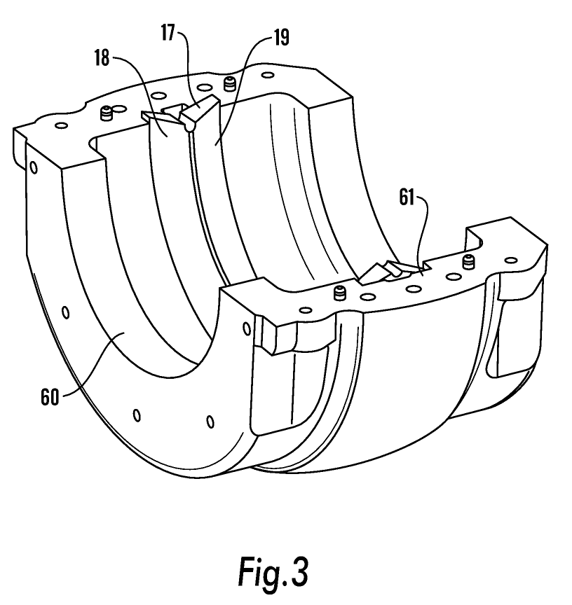

The inner ring 11 is in the form of two semicircular ring portions 31, 32 there being provided a cut or split 33, 34 on diametrically opposite sides of the inner ring 11 and as is clear from FIGS. 1 and 3, the line of the cut or split 33 is at an angle to the axis 14. In a similar way, the outer ring 17 is provided by two semicircular ring portions with diametrically opposed splits similar to the splits 33, 34. The angle of the angled cut 33, 34 to the axis of the bearing is preferably between 6 and 20 degrees.

We now describe the cage 21 in more detail, with reference to FIG. 2. The cage can be made of a variety of materials, for example machined from solid metal, investment cast in metal, vacuum moulded or injection moulded from engineering plastics material. The cage to be described is moulded of engineering plastics material.

The cage 21 comprises a pair of generally semicircular moulded plastic halves 31, 32, joined together at their ends 33, 34, the moulded halves 31, 32 each having three parallel continuous side wall portions 36, 37, 38 which (as seen in FIG. 1) overlap the ends of the rollers. Two (36, 37) of the sides form the sides of the moulded plastic halves 31, 32, and bars 41, 42 spaced apart along the continuous wall portions 36, 37, 38 join the continuous side wall portions 36, 37, 38 together. The adjacent bars 41, 42, and continuous wall portions 36, 37, 38 form two side by side series of pockets 43, 44 in which the two rows 22, 23 of rollers and retained.

The opposite ends 33, 34 of each semicircular cage half 31, 32, are formed with releasable fixing means 46, 47 such as steel spring clips engaging around end bar 48, 49.

Thus by providing the inner 11 and outer 17 rings and cage 21 in the form of two semicircular halves, the bearing assembly may be dismantled without removing the shaft which the bearing supports.

In use, the disassembled parts are fitted together as follows.

Assuming the bearing is to mount a shaft (not shown), the two semicircular inner ring portions 31, 32 are placed around the shaft, together with the two semicircular portions of the clamping rings 26, 27. The clamping rings may be bolted together by bolts 51, 52, 53, 54 shown in FIG. 1. When the inner ring portions are initially fitted to a shaft of the correct size, there will be a gap at both splits of approximately 0.5 mm. Clamping force between the inner ring 11 and the shaft depends on the induced load in the clamping ring bolts 51-54 when tightened to the specified torque. This system can generate a level of interference between inner ring 11 and shaft that is comparable to a shrink fit of a solid bearing.

The assembly continues with the two semicircular cage portions (with roller rows 22, 23 inserted in the relevant rows of pockets 43, 44) being mounted around the inner ring and joined together by means of the spring clips 46, 47. The two semicircular outer ring portions are then mounted around the cage. The two halves of a cartridge 62 surround the two semicircular outer ring portions and are then bolted together to from the complete assembly.

Disassembly is the reverse of assembly and as is clear the parts of the bearing, for example worn raceways and worn rollers may be replaced whilst leaving the shaft in situ. This is a considerable technical benefit not available hitherto in respect of taper bearings.

As set out above, a taper roller bearing is provided not only to provide a suitable radial load supporting bearing for the rotating shaft but also to absorb axial loads of the shaft with respect to the bearing. If the axial loads are in a single known direction, then a single row of rollers may be provided but we have described a bearing with respect to the Figures which includes two oppositely pitched rows of rollers which can therefore absorb axial loads in opposite directions.

Because the forces on a taper roller tend to move it along its axis, across the raceway, away from the apex of the cone, a retaining lip is required on one raceway to maintain the rollers in position. In the design shown the lip is on the inner race, but can be placed on the outer race to facilitate the manufacture of the races if required. As will be noted, the rollers have profiled (i.e. domed) end faces to facilitate the lubrication of the sliding contact.

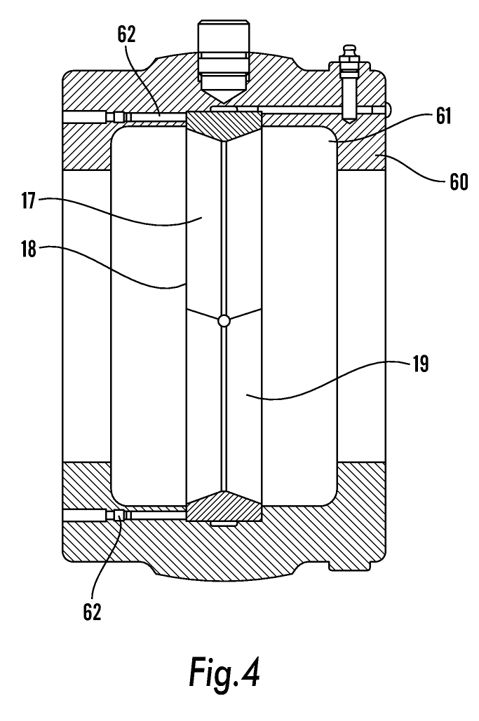

The outer ring 17 also contains both outer raceways 18, 19 and is split in a V-shape (FIG. 3) that provides a degree of location between the outer race halves. In a radially loaded cylindrical roller bearing, the load is supported by the rollers contained within an arc that extends roughly 30 degrees either side of the direction of action of the load. (The true extent of the arc depends on the magnitude of the load and the diametric clearance of the bearing). Normally the load is close enough to the vertical to avoid coincidence of loaded rollers and outer race joints. The addition of an axial load does not change this situation. In a taper bearing, if the load is predominantly in an axial direction it is shared among all the rollers and coincidence of loaded roller and outer race joint is unavoidable. As shown in FIG. 3, the outer ring is fitted into a cartridge 60 whose interior surface has been machined with a groove, called the outer race seat 61. There is a close tolerance fit between the outer ring 17 and the seat 61 that keeps the joint gap to a minimum. Screws 62 set in an axial direction around the circumference of the outer ring seat 61 (side screws) ensure that both halves of the outer ring 17 are pushed to one side of the seat 61 that acts as a register and the halves in circumferential alignment (FIG. 4).

Cartridge joints are reinforced with extra bolts to withstand the bursting force caused by the wedge action of the rollers.

In use, as the ratio of axial to radial loads increase, the resultant load is biased towards one row of rollers. The cage 21 (FIG. 2) retains both rows 22, 23 of rollers so that the unloaded row of rollers are driven by the loaded row of rollers, minimizing the risk of race damage due to roller skid.

The back-to-back arrangement allows the bearing to accommodate large tilting moments and ensure that the cartridge 60 aligns correctly in an outer housing. By using a lubricated and spherical connection between the cartridge 60 and the outer housing, very low frequency misalignments of the shaft axis can be accommodated by the movement between the spherical surfaces whilst maintaining the concentricity of seal and shaft which is not possible with spherical roller bearings.

When solid taper bearings are used in pairs, diametric clearance can be adjusted by means of spacer rings between either the inner or outer races. Negative clearance or preload is sometimes used to increase the stiffness of the bearing arrangements. In the new present arrangement, because the rings 11, 17 contain both tracks in a single part, spacers are not required. Bearing clearance is set to be in the standard clearance range and is determined by the dimensions and tolerances of the raceways and also by the size of the shaft on which the bearing is mounted.

The invention is not restricted to the details of the foregoing examples. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A taper roller bearing comprising
an inner ring including an inner tapered race;
an outer ring including an outer tapered race;
a cage mounted between the inner and outer tapered races; and
said cage mounting tapered rollers which engage the inner and outer races,
said inner ring and inner tapered race, outer ring and outer tapered race, and cage each comprising two generally semicircular parts, the two generally semicircular parts being mounted end-to-end to provide a circular component,
whereby the two generally semicircular parts of the inner ring and inner tapered race, outer ring and outer tapered race, and cage, may be separated from one another to allow the taper roller bearing to be dismantled when worn without removal of the component supported by the bearing.

2. A taper roller bearing as claimed in claim 1 in which,
said inner ring mounts a second inner tapered race,
said outer ring mounts a second outer tapered race,
said cage mounted between the second inner and outer tapered races, said cage mounting a second set of tapered rollers which engage the second inner and outer races, said inner ring and inner tapered race, outer ring and outer tapered race, and cage each comprising two generally semicircular parts, the two generally semicircular parts being mounted end-to-end to provide a circular component,
the taper of the second inner and outer races and the second set of rollers being oppositely disposed to the taper of the first inner and outer races and first set of rollers.

3. A taper roller bearing as claimed in claim 2 comprising a double row bearing with the rows set in a back-to-back format with inwardly convergent contact angles, whereby to provide a bi-directional thrust load carrying capability.

4. A taper roller bearing as claimed in claim 1 in which the inner ring is split by an angled cut to provide the two semicircular portions.

5. A taper roller bearing as claimed in claim 1 in which the outer ring is split by an angled cut to provide the two semicircular portions.

6. A taper roller bearing as claimed in claim 1 in which the inner and outer rings are split by angled cuts to provide the two semicircular portions.

7. A taper roller bearing as claimed in claim 4 in which the angle of the angled cut to the axis of the bearing is between 6 and 20 degrees.

8. A taper roller bearing as claimed in claim 5 in which the angle of the angled cut to the axis of the bearing is between 6 and 20 degrees.

9. A taper roller bearing as claimed in claim 6 in which the angle of the angled cuts to the axis of the bearing is between 6 and 20 degrees.

10. A taper roller bearing as claimed in claim 1 in which the inner ring mounts a shaft, and the inner ring is clamped to the shaft by clamping rings
